(19) United States
(12) Patent Application Publication
(10) Pub. No.: US 2018/0141175 A1
(43) Pub. Date: May 24, 2018

(54) MACHINE TOOL

(71) Applicants: Martin HUETTMANN, Wedemark (DE); Nikolaus LANGERT, Wuerzburg (DE)

(72) Inventors: Martin HUETTMANN, Wedemark (DE); Nikolaus LANGERT, Wuerzburg (DE)

(21) Appl. No.: 15/571,550

(22) PCT Filed: Apr. 27, 2016
(86) PCT No.: PCT/EP2016/000671

§ 371 Date: Nov. 3, 2017

(30) Foreign Application Priority Data
May 4, 2015 (DE) 10 2015 005 557.7

(51) Int. Cl. B23Q 1/01; B23Q 1/54

(52) U.S. Cl. CPC B23Q 1/015; B23Q 1/5425

(57) ABSTRACT

A machine tool for the computer-controlled machining of workpieces includes a machine stand and at least two clamping devices which are maintained next to each other in an adjusting and mobile manner, at least one tool receiving element being formed with one of the clamping devices and at least one tool receiving element being formed with the other clamping device. The clamping devices are maintained in an adjusting and mobile manner in the machine stand by a rotating mechanism including at least two rotational axes which are connected in series and which intersect each other. At least one linear guide is embodied between at least one of the clamping devices and the machine stand.

The invention pertains to a machine tool for the computer-controlled machining of workpieces, which comprises a machine stand and at least two clamping devices that are adjustably mounted next to one another, wherein at least one workpiece receptacle is formed by one of the clamping devices and at least one tool receptacle is formed by the other clamping device.

Known devices serve for mechanically separating, joining and coating workpieces, wherein the principal motions and adjusting motions between the workpiece receptacle and the tool receptacle required for carrying out this manufacturing process are realized with the aid of linear guides and rotary guides. To this end, the known devices typically comprise workpiece receptacles that are arranged on compound tables and tool receptacles that are arranged on processing heads, for example in the form of motor spindles. However, there also exist devices, in which the workpiece receptacles or the tool receptacles are moved on robotic arms. The disadvantage of using compound tables or robotic arms can be seen in that they require large motion spaces, the encapsulation of which for protecting against dirt and for realizing the corresponding occupational safety is quite elaborate. In addition, the use of compound tables or robotic arms is associated with long traveling distances that negatively affect the processing speeds and the component rigidities. However, a sufficiently rigid design of compound tables or robotic arms is quite elaborate and therefore associated with unfavorably high manufacturing costs.

The invention is therefore based on the objective of disclosing a machine tool with the same performance spectrums, the structural dimensions of which are significantly reduced.

According to the invention, this objective is attained by means of a machine tool with the characteristics of claim 1. Advantageous enhancements of the invention are disclosed in the dependent claims referring to claim 1.

The inventive machining tool is characterized in that the clamping devices respectively are adjustably held in the machine stand by means of a rotary mechanism with at least two rotational axes, which are connected in series and intersect one another, and in that at least one linear guide is formed between at least one of the clamping devices and the machine stand. Due to the serial connection of their rotational axes, the rotary mechanisms respectively feature a first actuating element, which is mounted in the machine stand about the first rotational axis, as well as a second actuating element, which is mounted on the first actuating element about a second rotational axis. The linear guide serves for adjusting the distance between the two clamping devices independently of the rotational position assumed by the rotary mechanisms, wherein the scope of the invention also includes embodiments, in which the linear guide is replaced with any suitable guide for adjusting the distance between the clamping devices. The motional interaction between the two rotary mechanisms and the linear guide makes it possible to generate all relative motions between the workpiece receptacle and the tool receptacle required for moving along any geometric contours in computer-controlled sequences. The relative motions therefore make it possible to position the workpiece and the tool within a workspace, as well as to align the workpiece and the tool relative to one another. Due to the superposition of the rotational motions, which can be carried out with the rotary mechanisms within a very confined space, the relative motions generated between the workpiece and the tool are comparatively large such that the inventive machine tool advantageously has a compact design and can be operated with high processing speeds.

According to a first enhancement of the invention, the linear guide is formed between one of the clamping devices and the rotary mechanism for mounting the clamping device. In this way, the mass to be moved about the linear guide is advantageously limited to that of the clamping device and the workpiece or tool received therein. A correspondingly designed linear guide has lightweight dimensions and therefore makes it possible to advantageously operate with high processing speeds. However, the scope of this invention naturally also includes embodiments, in which the linear guide is formed between the rotational axes of one of the rotary mechanisms or positioned in the machine stand between the rotary mechanisms.

According to a particularly preferred enhancement of the invention, a right angle is respectively formed between the intersecting rotational axes. Other angles are basically possible, but would unnecessarily complicate the programming of the control sequences required for the computer-controlled machining process.

It is furthermore preferred that the rotational axes formed between the machine stand and the rotary mechanisms are aligned parallel to one another. Although other alignments are basically possible, they would also unnecessarily complicate the programming of the control sequences required for the computer-controlled machining process.

According to another enhancement of the invention, the machine tool comprises more than two clamping devices, which are adjustably mounted next to one another, wherein at least one of their rotary mechanisms is arranged centrally and the other rotary mechanisms are distributed on the periphery of the centrally arranged rotary mechanism. If the clamping device of the centrally arranged rotary mechanism forms a tool receptacle and the peripheral clamping devices respectively form workpiece receptacles, a workpiece exchange can be carried out on at least one of the workpiece receptacles while a workpiece clamped in one of the other workpiece receptacles is machined with a tool in the centrally arranged tool receptacle. In this way, the set-up times can be significantly shortened. On the other hand, if the clamping device of the centrally arranged rotary mechanism forms a workpiece receptacle and the peripheral clamping devices respectively form tool receptacles, the tool receptacles can be fitted with different tools while a workpiece clamped in the central workpiece receptacle is machined on-the-fly by the different tools in the peripherally arranged tool receptacles. This likewise makes it possible to significantly shorten the set-up times. In an embodiment, it would be conceivable to guide the rotary mechanisms arranged on the periphery of the central rotary mechanism along a circular path in accordance with known rotary indexing tables.

According to another enhancement of the invention, at least one of the clamping devices features at least one motor spindle for carrying out cutting motions. If the tool consists of a rotating cutting tool, the clamping device forming the tool receptacle is realized as part of the motor spindle in the form of a so-called tool interface. If the tool consists of a lathe chisel, the clamping device forming the workpiece receptacle is realized in the form of a lathe chuck. The inventive machine tool advantageously covers a broad spectrum of machining operations if a rotary drive for carrying out cutting motions is assigned to both clamping devices.

In order to realize the control sequences required for the computer-controlled machining of workpieces as simple as possible, the intersecting rotational axes of at least one of the rotary mechanisms form an axial cross. If one of the clamping devices features a motor spindle, an axial node is formed by its rotational axis and the intersecting rotational axes of the rotary mechanism receiving the motor spindle. In order to arrange a workspace located between the clamping devices as axially proximal as possible, the first actuating elements, which are rotatably mounted in the machine stand about the first rotational axes, are preferably realized in the form of cranked shafts or cranked stub shafts.

Exemplary embodiments of the invention, from which other inventive characteristics can be gathered, are illustrated in the drawings. In these drawings:

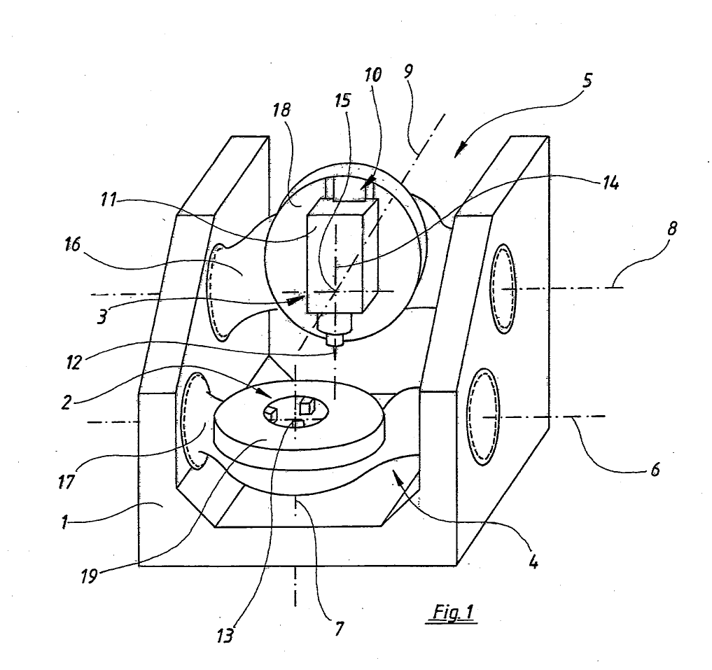

FIG. 1 shows a schematic perspective view of an inventive machine tool according to a first exemplary embodiment;

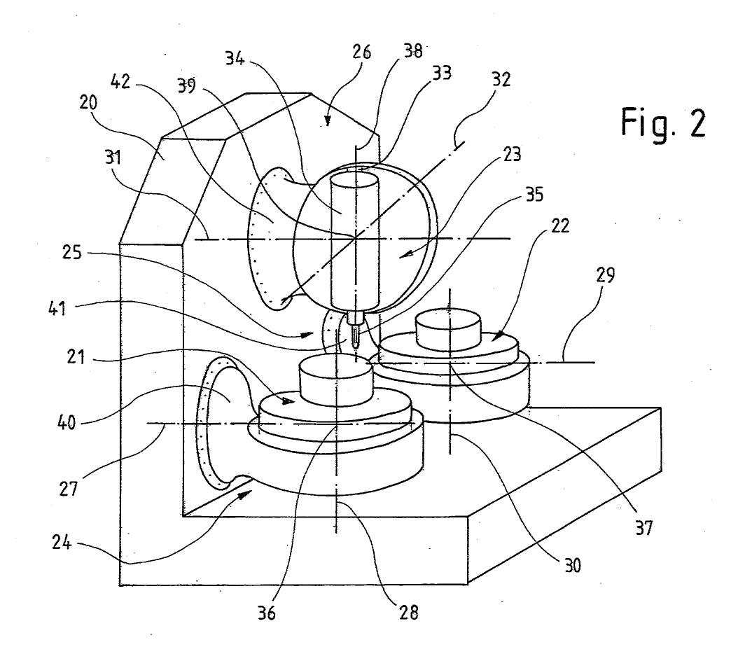

FIG. 2 shows a schematic perspective view of an inventive machine tool according to a second exemplary embodiment;

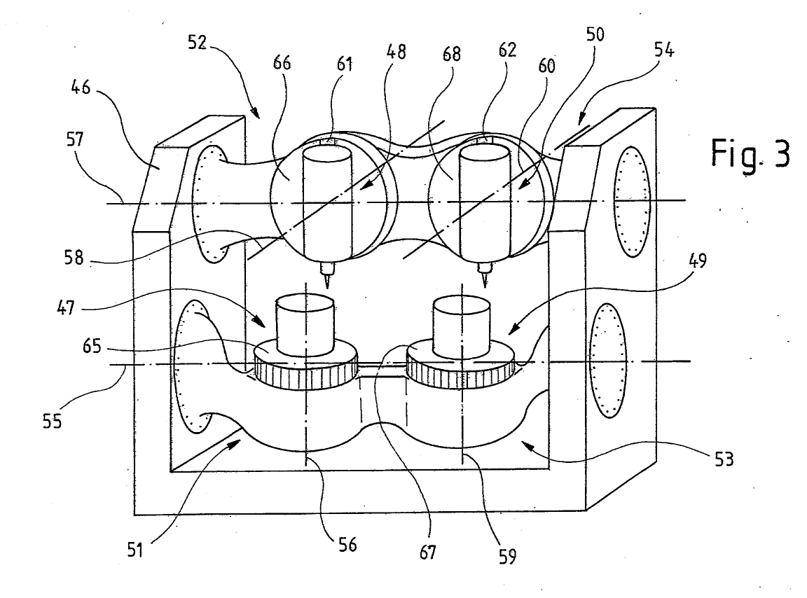

FIG. 3 shows a schematic perspective view of an inventive machine tool according to a third exemplary embodiment;

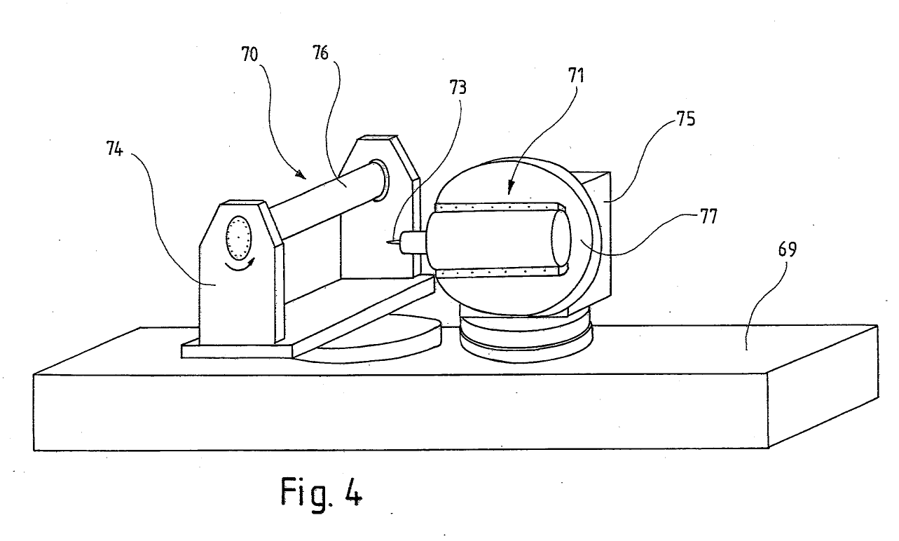

FIG. 4 shows a schematic perspective view of an inventive machine tool according to a fourth exemplary embodiment; and

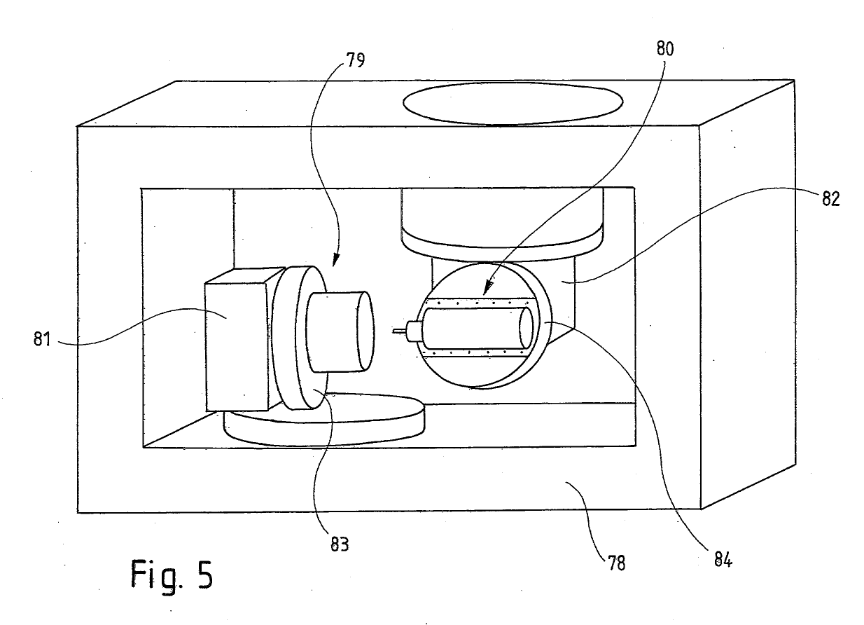

FIG. 5 shows a schematic perspective view of an inventive machine tool according to a fifth exemplary embodiment.

FIG. 1 shows a schematic perspective view of an inventive machine tool with a machine stand 1 and two clamping devices 2, 3 that are adjustably mounted next to one another, wherein a workpiece receptacle is formed by the clamping device 2 and a tool receptacle is formed by the clamping device 3. The clamping devices 2, 3 respectively are adjustably mounted in the machine stand 1 by means of rotary mechanisms 4, 5 with two rotational axes 6, 7 and 8, 9, which are connected in series and intersect one another. A linear guide 10 is formed between the clamping device 3 and the machine stand 1 and arranged between the clamping device 3 and the rotary mechanism 5 for mounting this clamping device. A right angle is respectively formed between the intersecting rotational axes 6, 7 and 8, 9 whereas the rotational axes 6, 8 formed between the machine stand 1 and the rotary mechanisms 4, 5 are aligned parallel to one another. The clamping device 3 features a motor spindle 11 for carrying out cutting motions with a tool 12 clamped in the clamping device 3. An axial cross 13 is formed by the intersecting rotational axes 6, 7 of the rotary mechanism 4 whereas an axial node 15 is formed by the rotational axis 14 of the motor spindle 11 and the intersecting rotational axes 8, 9 of the rotary mechanism 5 receiving the motor spindle 11. Due to the serial connection of their rotational axes 6, 7 and 8, 9, the rotary mechanisms 4, 5 respectively feature first actuating elements 16, 17, which are mounted in the machine stand 1 about the rotational axes 6, 8, as well as second actuating elements 18, 19, which are respectively mounted on the first actuating elements 16 and 17 about the rotational axes 7, 9. In order to arrange a workspace located between the clamping devices 2, 3 as axially proximal as possible, the first actuating elements 16, 17 mounted in the machine stand 1 are realized in the form of double-cranked shafts. The second actuating elements 18, 19 are realized in the form of rotary tables for receiving the clamping devices 2, 3.

FIG. 2 shows a schematic perspective view of the inventive machine tool according to a second exemplary embodiment, in which the machine tool comprises a machine stand 20 and three clamping devices 21, 22, 23 that are adjustably held next to one another, wherein a workpiece receptacle is respectively formed by the clamping devices 21, 22 and a tool receptacle is formed by the clamping device 23. The clamping devices 21, 22, 23 respectively are adjustably mounted in the machine stand 20 by means of rotary mechanisms 24, 25, 26 with two rotational axes 27, 28 and 29, 30 and 31, 32, which are connected in series and intersect one another. A linear guide 33 is formed between the clamping device 23 and the machine stand 20 and arranged between the clamping device 23 and the rotary mechanism 26 for mounting this clamping device. In this case, a right angle is also respectively formed between the intersecting rotational axes 27, 28 and 29, 30 and 31, 32 and the rotational axes 27, 29, 31 formed between the machine stand 20 and the rotary mechanisms 24, 25, 26 are likewise aligned parallel to one another. The rotary mechanism 26 of the clamping device 23 forming a tool receptacle is arranged centrally whereas the two other rotary mechanisms 24, 25 are distributed on the lower periphery of the centrally arranged rotary mechanism 26. The clamping device 23 forming a tool receptacle features a motor spindle 34 for carrying out cutting motions with a tool 35 clamped in the clamping device 23. An axial cross 36, 37 is respectively formed by the intersecting rotational axes 27, 28 and 29, 30 of the rotary mechanisms 24, 25 whereas an axial node 29 is formed by the rotational axis 38 of the motor spindle 34 and the intersecting rotational axes 31, 32 of the rotary mechanism 26 receiving the motor spindle 34. Due to the serial connection of their rotational axes 27, 28 and 29, 30 and 31, 32, the rotary mechanisms 24, 25, 26 respectively feature first actuating elements 40, 41, 42, which are mounted in the machine stand 20 about the rotational axes 27, 29, 31, as well as second actuating elements 43, 44, 45, which are respectively mounted on the first actuating elements 40, 41, 42 about the rotational axes 28, 30, 32. The first actuating elements 40, 41, 42 are respectively realized in the form of cranked stub shafts whereas the second actuating elements 43, 44, 45 are respectively realized in the form of rotary tables.

FIG. 3 shows a schematic perspective view of the inventive machine tool according to a third exemplary embodiment, in which the machine tool comprises a machine stand 46 and four clamping devices 47, 48, 49, 50 that are adjustably mounted next to one another, wherein a workpiece receptacle is respectively formed by the clamping devices 47, 49 and a tool receptacle is respectively formed by the clamping devices 48, 50. The clamping devices 47, 48, 49, 50 respectively are adjustably mounted in the machine stand 46 by means of rotary mechanisms 51, 52, 53, 54 with two rotational axes 55, 56 and 57, 58 and 55, 59 and 57, 60. Linear guides 61 and 62 are respectively formed between each of the two clamping devices 48, 50 forming a tool receptacle and the machine stand 46 and arranged between the clamping devices 48 and 50 and the respective rotary mechanisms 52 and 54 for mounting these clamping devices 48 and 50. The rotary mechanisms 52, 54 are interconnected by the common rotational axis 57 whereas the rotary mechanisms 51, 53 are interconnected by the common rotational axis 55. Due to the serial connection of their rotational axes 55, 56 and 57, 58 and 55, 59 and 57, 60, the rotary mechanisms 51, 52, 53, 54 respectively feature first actuating elements 63 and 64, which are mounted in the machine stand 46 about the rotational axes 55, 57, as well as second actuating elements 65, 66, 67, 68, which are respectively mounted on the first actuating elements 63, 64 about the rotational axes 56, 58, 59, 60. The two first actuating elements 63, 64 are respectively realized in the form of double-cranked shafts whereas the second actuating elements 65, 66, 67, 68, which′ are respectively coupled to one of the double-cranked shafts in two pairs, are realized in the form of rotary tables.

FIG. 4 likewise shows a schematic perspective view of the inventive machine tool, however, in the form of a fourth exemplary embodiment that is not described as extensively. In this exemplary embodiment, the machine tool comprises a machine stand 69 in the form of a base plate and two clamping devices 70, 71 that are adjustably mounted next to one another, wherein a workpiece receptacle is formed by the clamping device 70 and a tool receptacle is formed by the clamping device 71. Due to the serial connection of their rotational axes, the rotary mechanisms respectively feature first actuating elements 74, 75, which are mounted in the machine stand 69 about rotational axes, as well as second actuating elements 76, 77, which are respectively mounted on the first actuating elements 74, 75 about rotational axes. In this exemplary embodiment, the first actuating element 74 is realized in the form of a two-point shaft bearing and the first actuating element 75 is realized in the form of a single-cranked stub shaft. The second actuating element 76 assigned to the clamping device is realized in the form of a receiving shaft for a workpiece whereas the second actuating element 77 assigned to the clamping device 71 is once again realized in the form of a rotary table.

FIG. 5 likewise shows a schematic perspective view of the inventive machine tool, however, in the form of a fifth exemplary embodiment that is also not described as extensively. In this case, the machine tool features a machine stand 78 in the form of a frame structure and two clamping devices 79, 80 that are adjustably mounted next one another, wherein a workpiece receptacle is formed by the clamping device 79 and a tool receptacle is formed by the clamping device 80. Due to the serial connection of their rotational axes, the rotary mechanisms also respectively feature first actuating elements 81, 82, which are mounted in the machine stand 78 about rotational axes, as well as second actuating elements 83, 84, which are respectively mounted on the first actuating elements 81, 82 about rotational axes. In this exemplary embodiment, both first actuating elements 81, 82 are realized in the form of cranked stub shafts and both second actuating elements 83, 84 realized in the form of rotary tables.

All characteristics disclosed in the preceding description and in the claims can be arbitrarily combined with the characteristics of the independent claim. The disclosure of the invention is therefore not limited to the described or claimed combinations of characteristics, but all sensible combinations of characteristics within the scope of the invention rather should be considered as disclosed.

1. A machine tool for the computer-controlled machining of workpieces, comprising a machine stand and at least two clamping devices that are adjustably mounted next to one another, wherein at least one workpiece receptacle is formed by one of the clamping devices and at least one tool receptacle is formed by the other clamping device,
wherein the clamping devices (2, 3; 21-23) respectively are adjustably held in the machine stand (1; 20) by means of rotary mechanisms (4, 5; 24-26) with at least two rotational axes (6-9; 27-32), which are connected in series and intersect one another, and
wherein at least one linear guide (10; 33) is formed between at least one of the clamping devices (2, 3; 21-23) and the machine stand (1; 20).

2. The machine tool according to claim 1, wherein the linear guide (10; 33) is formed between one of the clamping devices (2, 3; 21-23) and the rotary mechanism (4, 5; 24-26) for mounting the clamping device.

3. The machine tool according to claim 1, wherein a right angle is respectively formed between the intersecting rotational axes (6-9; 27-32).

4. The machine tool according to claim 1, wherein the rotational axes (6, 8; 27, 29, 31) of the intersecting rotational axes (6-9; 27-32), which are formed between the machine stand (1; 20) and the rotary mechanisms (4, 5; 24-26), are aligned parallel to one another.

5. The machine tool according to claim 1, wherein it comprises more than two clamping devices (21-23), which are adjustably mounted next to one another, wherein at least one of their rotary mechanisms (24-26) is arranged centrally and the other rotary mechanisms (24, 25) are distributed on the periphery of the centrally arranged rotary mechanism (26).

6. The machine tool according to claim 1, wherein at least one of the clamping devices (2, 3; 21-23) features at least one motor spindle (11; 34) for carrying out cutting motions.

7. The machine tool according to claim 1, wherein an axial cross (13, 36; 37) is formed by the intersecting rotational axes (6-9; 27-32) of at least one of the rotary mechanisms (4, 5; 24-26).

8. The machine tool according to claim 6, wherein an axial node (15; 39) is formed by the rotational axis (14; 38) of the motor spindle (11; 34) and the intersecting rotational axes (6-9; 27-32) of the rotary mechanism (5; 26) receiving the motor spindle (11; 34).
